(19) United States
(12) Patent Application Publication
(10) Pub. No.: US 2022/0083097 A1
(43) Pub. Date: Mar. 17, 2022

(54) DEVICE ACCESSORIES WITH ATTACHMENT SLOTS

(71) Applicant: Hewlett-Packard Development Company, L.P., Spring, TX (US)

(72) Inventors: Derek Kanas, Spring, TX (US); Chan Woo Park, Spring, TX (US)

(73) Assignee: Hewlett-Packard Development Company, L.P., Spring, TX (US)

(21) Appl. No.: 17/419,794

(22) PCT Filed: Apr. 29, 2019
(86) PCT No.: PCT/US2019/029576

§ 371 Date: Jun. 30, 2021

(51) Int. Cl. G06F 1/16; G06F 3/0354

(52) U.S. Cl. CPC G06F 1/1607; G06F 2200/1632; G06F 3/03545

(57) ABSTRACT

In an example, a device accessory may include a body and an attachment slot. The attachment slot may extend into the body. The attachment slot may receive an accessory tab attached to an electronic device. The attachment slot may receive the accessory tab within the attachment slot so as to removably engage with the accessory tab. The body may be retained on to the accessory tab when the attachment slot is engaged with the accessory tab.

### BACKGROUND

Electronic devices such as computing devices may have a number of ways a user may interact with the device. Some electronic devices may have a display and a keyboard and/or mouse with which a user may interact with the display. Other electronic devices may have a touch-screen display and a user may interact with such a display using his or her hand, finger, or other appendage. Further, some electronic devices having a touch-screen display may be used in conjunction with a stylus, pointer, or other type of device accessory in order to enable a user to interact with the display.

### BRIEF DESCRIPTION OF THE DRAWINGS

FIG. 1A is a perspective view of an example device accessory having an attachment slot.

FIG. 1B is a detail perspective view of the example device accessory of FIG. 1A.

FIG. 1C is a detail perspective view of the example device accessory of FIG. 1A.

FIG. 1D is a detail perspective view of the example device accessory of FIG. 1A.

FIG. 1E is a cross-sectional view of the example device accessory of FIG. 1A.

FIG. 2A is a perspective view of an electronic device having an example device accessory.

FIG. 2B is a detail perspective view of the electronic device and example device accessory of FIG. 2A.

FIG. 2C is a detail perspective view of the electronic device and example device accessory of FIG. 2A.

FIG. 2D is a detail perspective view of the electronic device and example device accessory of FIG. 2A.

FIG. 2E is a perspective cutaway view of the example device accessory of FIG. 2A.

### DETAILED DESCRIPTION

Electronic devices such as computing devices may be utilized in various ways. In some situations, electronic devices may be interacted with by a user through various types of interfaces, for example, mice, trackpads, keyboards, trackballs, etc. In some situations, an electronic device may include a touch-screen display. Users may interact with a touch-screen display by tapping, swiping, pinching, etc. on the display directly with his or her finger, hand, or other appendage. In further situations, electronic devices may be used in conjunction with a device accessory such as a stylus, pointer, etc. A user may use the device accessory to tap or virtually draw or write on the touch-screen display instead of using his or her appendage. Device accessories such as a stylus may provide enhanced functionality, accuracy, or other benefits over using a hand or finger to interact with a touch-screen display.

It may be desirable to stow or store a device accessory when it is not in use so as to avoid losing such device accessory. When stowing or storing the device accessory in a bag or pocket, it may prove difficult to find the device accessory quickly and/or it may still be susceptible to inadvertent loss. In some situations, electronic devices may include a slot, channel, or other recess into which a device accessory may be inserted for stowage. Such internal stowing techniques occupy internal volume of the electronic device, which is often at a premium. In other situations, electronic devices may include an external attachment loop, magnet, or sticky portion which may enable a user to stow a device accessory directly on the exterior of the electronic device. These existing external stowage methods or devices may detract from an electronic device's aesthetic appearance or industrial design. Further, such existing techniques may also fail to provide a sufficiently-secure attachment for the device accessory, which may lead to inadvertent loss of the device accessory. In some situations, it may be desirable to provide an external attachment ability with an electronic device for a device accessory that is both a secure attachment for the device accessory and also maintains the positive aesthetics or industrial design of the electronic device.

Implementations of the present disclosure provide example device accessories with attachment slots for stowing or attaching the device accessories to the exterior of electronic devices. The attachment slot on such example device accessories may receive and retain an accessory tab protruding from the exterior of an electronic device in order to attach the device accessory to the exterior of the electronic device in a secure and attractive fashion.

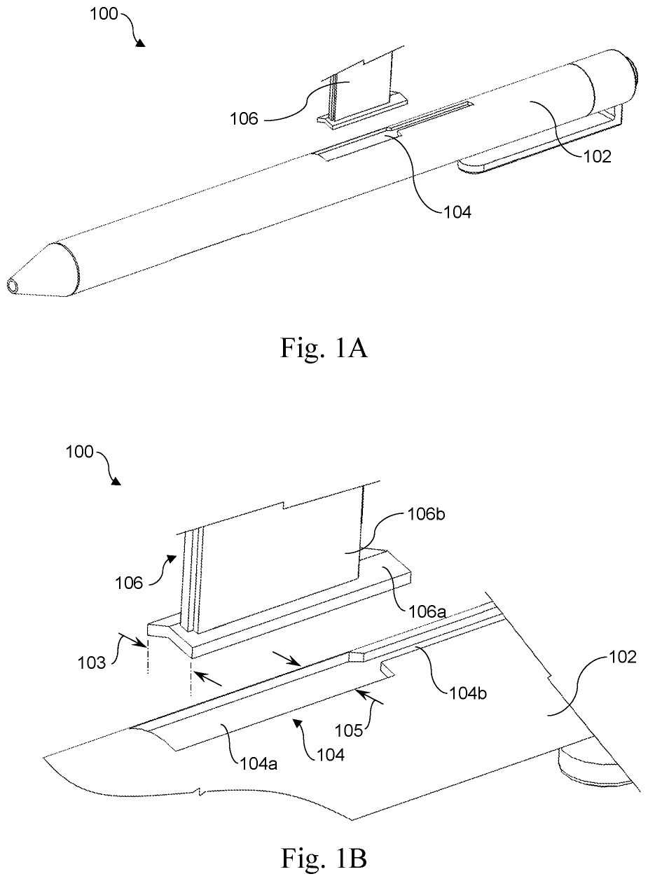

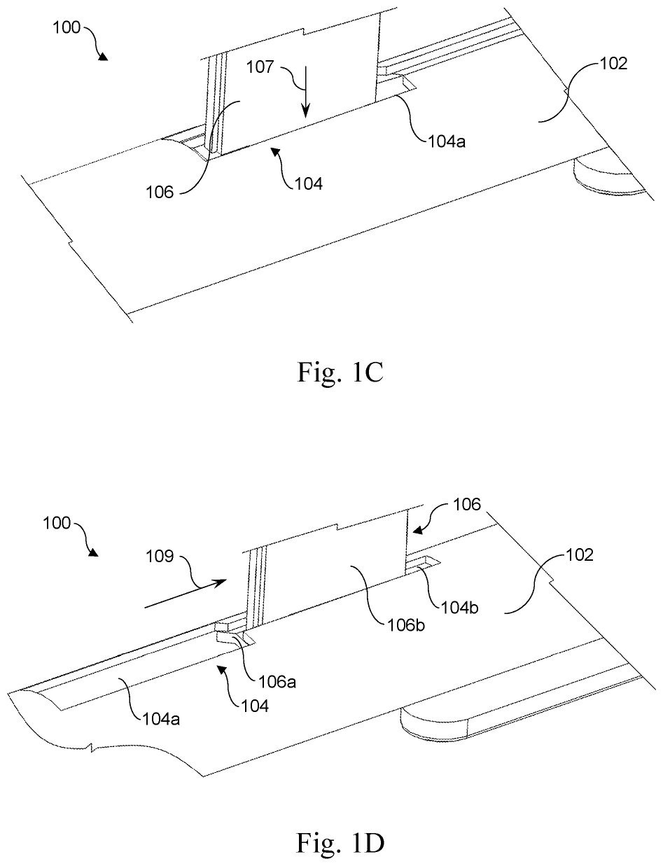

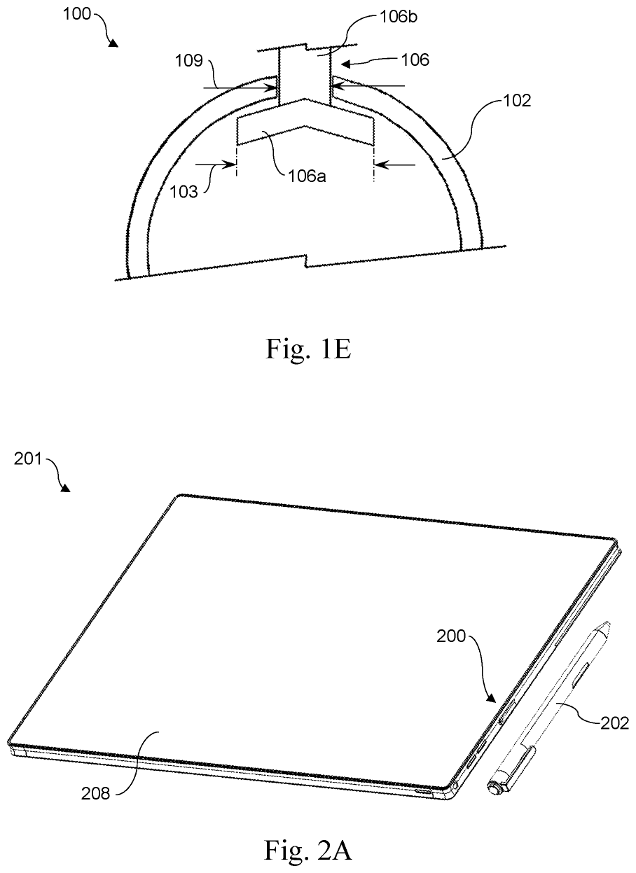

Referring now to FIG. 1A, a perspective view of an example device accessory 100 having an attachment slot 104 is illustrated. In some implementations, the device accessory 100 may be a stylus or pointer, for use with a touch-screen display. In other implementation, the device accessory 100 may be another type of accessory or tool, such as a traditional pen or pencil, or a screwdriver or the like to assist in disassembly of an electronic device. The device accessory 100 may include a body 102, and the attachment slot 104 may extend into the body 102. The body 102 may be an elongate structure or member and may be partially or wholly hollow. In some implementations, the body 102 may have a longer axial length than a radial length. While illustrated as round or cylindrical, the body 102 may have one of a number of shapes. In further implementations, the body 102 may have a square or rectangular cross-sectional shape, a hexagonal cross-sectional shape, or a different type of cross-sectional shape. In examples wherein the body 102 is not a round shape, the body 102 may have an axial length that is greater than its width or thickness (referred to as radial length in round or cylindrical examples).

As described above, the attachment slot 104 may receive an accessory tab 106 attached to an electronic device (not shown). The accessory tab 106 may be a rigid or semi-rigid member and may be attached to, or a part of, a larger overall device, e.g., an electronic device. The attachment slot 104 may receive the accessory tab 106 within the attachment slot 104 to removably engage with the accessory tab 106. The body 102 may be retained on to the accessory tab 106 when the attachment slot 104 is engaged with the accessory tab 106, and, thus, the device accessory 100 may be stowed or mounted on to the larger overall device.

Referring now to FIG. 1B, a detail perspective view of the device accessory of FIG. 1A is illustrated. In some examples, the attachment slot 104 may have a first portion 104a and a second portion 104b, extending from the first portion 104a. The second portion 104b may be narrower than the first portion 104a, and may extend longitudinally from the first portion, or along an axial direction of the body 102. In some implementations, the attachment slot 104 may be a window, opening, or aperture in a wall of the body 102, and extend through a wall thickness of the body 102 into a hollow interior portion of the body 102.

In some implementations, the accessory tab 106 may include a retention lug 106a and a neck portion 106b. The neck portion 106b, in some examples, may be narrower or thinner in width than the retention lug 106a. The first portion 104a of the attachment slot 104 may be wider than the retention lug 106a of the accessory tab 106, and the second portion 104b may be narrower than the retention lug 106a. More specifically, the retention lug 106a may have a lug width 103, which may be narrower than a first slot width 105. In other words, the first portion 104a may be sized to receive the retention lug 106a. Thus, the retention lug 106a of the accessory tab 106 may be inserted into the first portion 104a of the attachment slot 104, as illustrated in FIG. 1C. FIG. 1C is another detail perspective view of the device accessory 100 of FIG. 1A. The accessory tab 106, or the retention lug 106a thereof, has been inserted into the first portion 104a of the attachment slot 104, for example, along direction 107. Stated differently, the body 102 has been engaged with the accessory tab 106 such that the first portion 104a of the attachment slot 104 has received the retention lug 106a of the accessory tab 106 within the attachment slot 104.

Referring now to FIG. 1D, another detail perspective view of the device accessory 100 of FIG. 1A is illustrated. After the accessory tab 106 has been engaged with the attachment slot 104, and/or the retention lug 106a has been received by the first portion 104a, the accessory tab 106 may be longitudinally slid along the axial direction of the body 102, e.g., along direction 109, so as to insert the neck portion 106b into the second portion 104b of the attachment slot 104. Thus, the second portion 104b may be sized to receive the neck portion 106b. Referring additionally to FIG. 1E, a cross-sectional view of the example device accessory 100 of FIG. 1A is illustrated. In the current view, the accessory tab 106 is illustrated as being fully engaged with the attachment slot 104 so as to provide a secure attachment between the body 102 and the accessory tab 106. The second portion 104b of the attachment slot 104 may have a second slot width 109, which may be wider than a width of the neck portion 106b so as to receive the neck portion 106b within the second portion 104b. Further, the second slot width 109 may be narrower than the lug width 103 of the retention lug 106a so as to prevent the retention lug 106a from being pulled through the second portion 104b of the attachment slot 104 when the body 102 is fully engaged with the accessory tab 106. Since the retention lug 106a is wider than the second portion 104b of the attachment slot 104, the accessory tab 106 provides a secure way to stow the device accessory 100 to the device to which the accessory tab 106 is attached. It should be noted that the accessory tab 106, and/or the retention lug 106a thereof may have one of a number of shapes. In the illustrated examples, the retention lug 106a has a V-shaped structure, but in other examples, it may have another shape, e.g., a T-shape, trapezoidal shape, or any shape in which the lug width 103 is larger or wider than the second slot width 109.

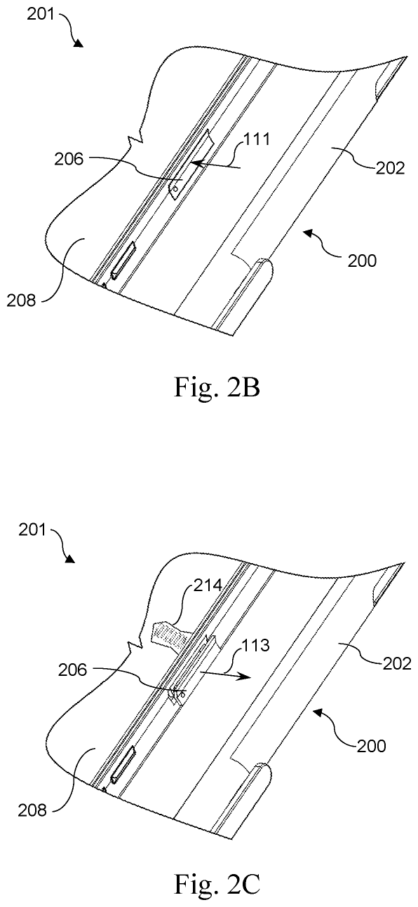

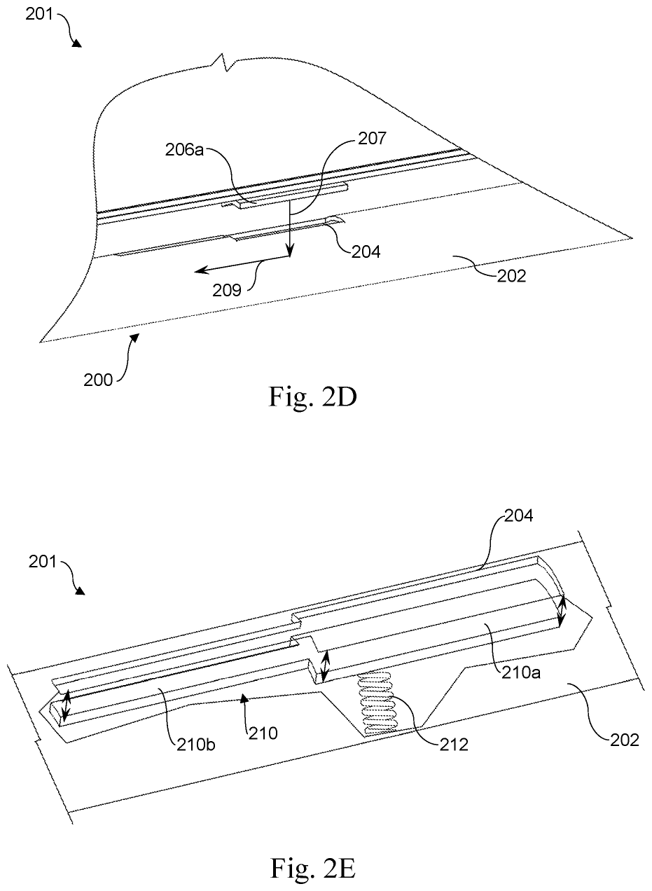

Referring now to FIG. 2A, a perspective view of an electronic device 201 having an example device accessory 200 is illustrated. Example device accessory 200 may be similar to example device accessory 100, described above. Further, the similarly-named elements of example device accessory 200 may be similar in function and/or structure to the respective elements of example device accessory 100, as they are described above. The electronic device 201, in some implementations, may be a computing device such as a tablet computer, notebook computer, desktop computer, smartphone, or other type of computing device. In further implementations, the electronic device 201 may be a different type of device, or a portion thereof, such as an imaging device or an additive manufacturing machine. In yet further implementations, the electronic device 201 may be any type of device having a touch-screen display.

The electronic device 201 may include a chassis 208. Chassis 208 may be a housing, or a portion thereof, and may enclose other components of the electronic device 201 such as processors, memory, storage disks, and the like. In some implementations, the chassis 208 may support, at least in part, or be coupled to, a display or touch-screen display of the electronic device 201. Referring now to FIG. 2B, a detail perspective view of the electronic device 201 is illustrated. Electronic device 201 may include an accessory tab 206, in some implementations, to removably engage with the device accessory 200, or a body 202 thereof. The accessory tab 206 may be attached to the chassis 208 and may be movable between a deployed position extending from the chassis 208 (FIG. 2C) and a stowed position within the chassis 208 (FIG. 2B). In some implementations, the accessory tab 206 may be flush with an exterior of the chassis 208 when disposed in the stowed position. Having a flush position with chassis 208 may help hide the accessory tab 206 when it is not in use and may preserve the aesthetics and industrial design of the electronic device 201.

In some implementations, in order to move the accessory tab from the stowed position to the deployed position, a push-to-release technique may be employed. In other words, in order to move the accessory tab 206 to the deployed position, the accessory tab 206 may be pushed further in the direction of the stowed position, e.g., along direction 111, in order to be unlatched. The accessory tab 206 may then extend out from the chassis 208 in order to be engaged with the device accessory 200, or the body 202 and/or attachment slot thereof. Referring now to FIG. 2C, another detail perspective view of the electronic device 201 of FIG. 2A is illustrated. The accessory tab 206 has now been moved along direction 113 from the stowed position to the deployed position, and is ready to be engaged with the body 202 of the device accessory. In some implementations, the electronic device 201 may further include a tab bias member 214, shown in cutaway, disposed within the chassis 208. The tab bias member 214 may be a resilient component capable of elastic deformation, e.g., a spring. The tab bias member 214 may urge the accessory tab 206 towards the deployed position.

Referring now to FIG. 2D, another detail perspective view of the electronic device 201 is illustrated wherein the device accessory 200 is to be coupled to or engaged with the accessory tab 206. The accessory tab 206, now being in the deployed position, extends from the chassis 208 such that a retention lug 206a of the accessory tab 206 is spaced away from the chassis 208. The accessory tab 206 may also have a neck portion attached to the retention lug 206a, wherein the neck portion is to extend the retention lug 206a out of the chassis 208 when the accessory tab 206 is in the deployed position so as to space the retention lug 206a sufficiently away from the chassis 208 that a wall thickness of the body 202 of the device accessory can fit in between the retention lug 206a and the chassis 208 when the device accessory 200 is engaged with the accessory tab 206. In order to engage the device accessory 200, or the body 202 thereof, with the accessory tab 206, the retention lug 206a may be inserted into a first portion of an attachment slot 204, e.g., along direction 207, and then the device accessory 200 may be slid longitudinally relative to the chassis 208 and the accessory tab 206, e.g., along direction 209, such that the retention lug 206a is disposed underneath a second portion of the attachment slot 204. The second portion may be narrower than a lug width of the retention lug 206a such that the retention lug 206a cannot be pulled through the second portion of the attachment slot. Thus, the device accessory 200 is securely stowed to the electronic device 201 when the accessory tab 206 is engaged with the attachment slot 204. In order to remove the device accessory 200, e.g., if a user desires to use it, the device accessory 200 can be slid relative to the chassis 208, e.g., in a direction opposite to direction 209, until the retention lug 206a is aligned with the first portion of the attachment slot 204. The device accessory 200 may then be lifted off of or removed from engagement with the accessory tab 206 by the retention lug 206a being removed through the first portion of the attachment slot 204.

Referring now to FIG. 2E, a detail cutaway view of the body 202 of the device accessory 200 is illustrated. In some implementations, the device accessory 200 may further include a slot door 210 to substantially fill the attachment slot 204 when the slot door 210 is in a closed position. Thus, in some examples, the slot door 210 may have a profile substantially matching that of the attachment slot 204. Specifically, the slot door 210 may have a first door portion 210a that substantially matches the size and shape, albeit slightly smaller in dimensions, of the first portion of the attachment slot 204. Similarly, the slot door 210 may have a second door portion 210b that substantially matches the size and shape of the second portion of the attachment slot 204. Further, the device accessory 200 may also include a bias member 212. The bias member 212 may be a resilient component capable of elastic deformation, e.g., a spring, and may urge the slot door 210 towards the closed position. In the process of engaging the device accessory 200 with the accessory tab 206 for stowage, the accessory tab 206 may push the slot door 210 out of the closed position, revealing the attachment slot 204. Thus, when the device accessory 200 is being used and is not engaged with the accessory tab 206, the slot door 210 may provide a clean and aesthetically pleasing appearance to the device accessory 200 by filling and this hiding the attachment slot 204.

What is claimed is:

1. A device accessory, comprising:
a body; and
an attachment slot extending into the body,
wherein the attachment slot is to receive an accessory tab attached to an electronic device within the attachment slot to removably engage with the accessory tab, the body to be retained on to the accessory tab when engaged.

2. The device accessory of claim 1, wherein the attachment slot has a first portion and a second portion, narrower than the first portion and extending longitudinally from the first portion, wherein the first portion is wider than a retention lug of the accessory tab, and the second portion is narrower than the retention lug of the accessory tab.

3. The device accessory of claim 1, further comprising a slot door to substantially fill the attachment slot when in a closed position.

4. The device accessory of claim 3, wherein the accessory tab is to push the slot door out of the closed position upon the attachment slot being engaged with the accessory tab.

5. The device accessory of claim 3, further comprising a bias member to urge the slot door towards the closed position.

6. The device accessory of claim 3, wherein the slot door has a profile substantially matching that of the attachment slot.

7. The device accessory of claim 1, wherein the body is an elongate structure having a longer axial length than a radial length.

8. The device accessory of claim 1, wherein the device accessory is a stylus for use with a touch-screen display of the electronic device.

9. An electronic device, comprising:
a chassis;
an accessory tab attached to the chassis and movable between a deployed position and a stowed position; and
a device accessory, comprising;
a body; and
an attachment slot extending into the body to removably engage with the accessory tab when the accessory tab is in the deployed position, the attachment slot comprising:
a first portion sized to receive a retention lug of the accessory tab; and
a second portion narrower than a width of the retention lug and extending longitudinally from the first portion.

10. The electronic device of claim 9, further comprising a tab bias member disposed within the chassis to urge the accessory tab towards the deployed position.

11. The electronic device of claim 10, wherein the accessory tab is to move from the stowed position to the deployed position upon being pushed further in the direction of the stowed position to be unlatched.

12. The electronic device of claim 9, wherein the accessory tab is flush with the chassis when disposed in the stowed position.

13. The electronic device of claim 9, wherein the accessory tab comprises a neck portion attached to the retention lug, the neck portion to extend the retention lug out of the chassis when the accessory tab is in the deployed position.

14. A computing device, comprising:
a chassis;
a display coupled to the chassis;
an accessory tab attached to the chassis and movable between a stowed position within the chassis and a deployed position extending out of the chassis; and
a device accessory, comprising:
a body; and
an attachment slot comprising a first portion and a second portion, narrower than the first portion, extending into the body, the first portion to receive a retention lug of the accessory tab when the accessory tab is in the deployed position.

15. The computing device of claim 14, wherein the second portion of the attachment slot is sized to receive a neck portion of the accessory tab and smaller than a width of the retention lug.
